(19) United States
(12) Patent Application Publication
(10) Pub. No.: US 2012/0078753 A1
(43) Pub. Date: Mar. 29, 2012

(54) Business Transaction Network System

(76) Inventor: CHUN LUNG LIN, Taipei City (TW)

(21) Appl. No.: 13/237,939

(22) Filed: Sep. 21, 2011

(30) Foreign Application Priority Data
Sep. 28, 2010 (TW) 100107828

(51) Int. Cl. G06Q 30/06

(52) U.S. Cl. 705/26.43

(57) ABSTRACT

A network business transaction system includes a foreground system and a background system. The foreground system has an order module. The background system has a commodity management module for sellers to share their own commodities with other sellers for consignment sale, and to share commodities of the other sellers in their own online stores for selling as agent for buyers to shop and purchase. When the commodity is owned by the seller, the commodity management module notifies the seller for account processing and commodity delivery processing. When the commodity is a commodity for consignment sale, the commodity management module notifies the original seller of the commodity who owned the commodity for account processing and commodity delivery processing. Therefore, each seller in the system can determine whether its commodities are willing to share with other sellers for consignment sale to ensure better product circulation.

### BACKGROUND OF THE PRESENT INVENTION

1. Field of Invention

The present invention relates to the technology of business transaction network, and more particular to a business transaction network system, in which commodities of sellers can be supplied to sell and deliver with each other through an ordering module and a commodity management module, so that the commodities can be rapidly circulated.

2. Description of Related Arts

With the vigorous development of Internet, electronic commerce has been well developed. Through some characteristic of the electronic commerce platform, such as diversity, immediacy and free of space limitation, the business transaction network becomes the most frequently used shopping method, in which each online member can setup his or her own online store on the network platform, and at the same time, the online members may purchase any commodity they needed on the network platform, thereby online shopping becomes more convenience.

The traditional online shopping platform (system) mainly provides a business transaction model between a seller and a consumer, wherein the sellers release commodity information on their online stores via a login module and a commodity module, so that the consumers can browse commodities of the sellers and purchase the commodities via the login module, wherein the shopping information is sent to a central server to complete a transaction. Substantially, the buyer can only purchase commodities of the seller through a single online store on the platform. Therefore, when the seller does not carry such commodity or the commodity is out of shock, the buyer will be unable to purchase such commodity. Thus, the buyers have to spend more time to browse and search for the commodity that they needed and being on sale by other sellers on the platform. Accordingly, not only the buyers have to spend more time in shopping, but also that the quantity and types of commodity of each seller are limited due to the cost and capital concern. It greatly reduces the practicality of the business transaction network system.

Therefore, how to develop a business transaction network system, that can enable the sellers to supply and circulate their commodities with each other so that the sellers can sell various kinds of commodity without hoarding goods and, furthermore, the buyer can rapidly purchase the commodity that they needed in order to improve the practicality of the business transaction network system, is what the invention would like to disclose in the present invention.

### SUMMARY OF THE PRESENT INVENTION

The invention is advantageous in that it provides a business transaction network platform, in which online members not only can sell their own commodities, but also can supply their commodities to other sellers for selling, and that, at the same time, each of the online members can sell commodities of other sellers, resulting in a more rapid product circulation.

Another advantage of the invention is to a business transaction network platform, which can provide the most complete transaction, management, research, and sale functions so as to enhance the utility of the business transaction network.

In order to achieve above objectives, the present invention provides a business transaction network platform, which comprises a foreground system and a background system, wherein the foreground system comprises:

a login module for buyers and sellers inputting personal information thereof, which is linked to a commodity database for enabling the buyers to browse commodities in the commodity database;

a shopping cart module for the buyers shopping and purchasing the commodities in the commodity database; and

an order module having an order database for transmitting shopping information to the background system when any of the buyers purchases any of the commodities in the commodity database.

The background system comprises a commodity management module for the sellers to share their own commodities with the other sellers for consignment sale and to share commodities of the other sellers in their own online stores for selling as agent for buyers to shop and purchase, wherein each of the commodities is able to be distinguished by the order module for whether it is a commodity owned by the seller or a commodity shared from the other sellers for consignment sale, wherein when the commodity is owned by the seller, the commodity management module notifies the seller for account processing and commodity delivery processing, wherein when the commodity is a commodity for consignment sale, the commodity management module notifies the original seller of the commodity who owned the commodity for account processing and commodity delivery processing.

In comparison with the prior arts, the business transaction network system of the present invention mainly provides the order module and the commodity management module to enable the sellers to determine whether one or more of their commodities are able to be selling by the other sellers as agent, and to determine whether they like to sell commodities owned by the other sellers in the business transaction network system as agent, so that the circulation of that commodity is enhanced for sale, and the sellers do not need to hoard various kinds of commodity. In addition, the order module can process account management to provide more clear and detail account information for ease of the sellers to manage their commodities and accounts, resulting in better overall utility of the business transaction network system of the present invention.

### BRIEF DESCRIPTION OF THE DRAWINGS

FIG. 1 is a block diagram of a business transaction network system according to a preferred embodiment of the present invention.

FIG. 2 is a block diagram illustrating the business transaction network system according to the above preferred embodiment of the present invention.

### DETAILED DESCRIPTION OF THE PREFERRED EMBODIMENT

The following disclosure is an implement of the present invention through a preferred embodiment, through which people skilled in this art are easy to know the features and functions of the present invention.

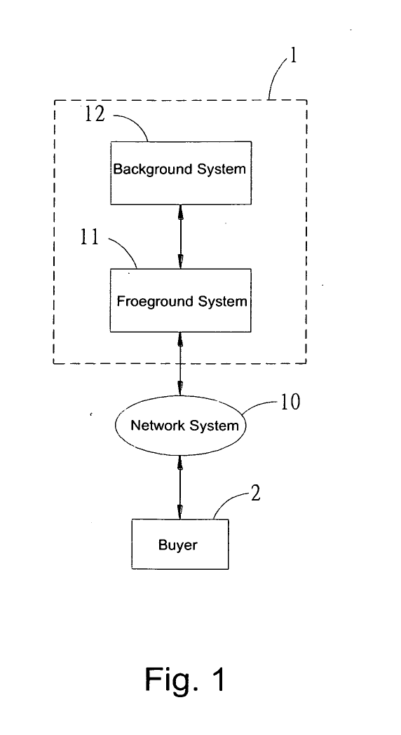

Referring to FIG. 1, a block diagram illustrating a business transaction network system according to a preferred embodiment of the present invention is shown. The business transaction network system 1 of the present invention comprises a foreground system 11 and a background system 12. Substantially, the background system 12 is adapted for providing commodity service for sellers. Buyers (consumers) 2 are able to login the foreground system 11 and shop and purchase commodities through a network system 10 such as the internet or cellular network. The network system 10 could be a cable network or a wireless network.

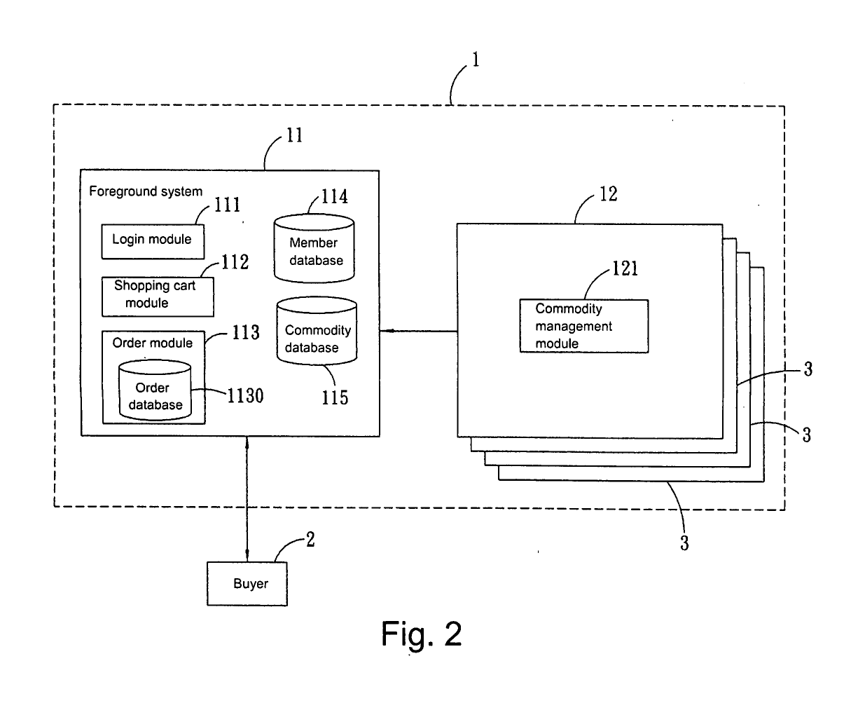

Referring to FIG. 2, a block diagram according to the preferred embodiment of the present invention is illustrated. As shown in the figure, the business transaction network system 1 comprises the foreground system 11 and the background system 12. The foreground system at least comprises a login module 111, a shopping cart module 112, an order module 113, a member database 114, and a commodity database 115. The login module 111 is provided for the buyers and the sellers to input personal information and is linked to the commodity database 115, so that the buyers 2 can browse the commodities in the commodity database 115. The shopping cart module 112 is provided for the buyers 2 to shop and purchase the commodities in the commodity database 115. The order module 113 has an order database 1130 for transmitting shopping and purchasing information to the background system 12 when any of the buyers 2 purchases any of the commodities in the commodity database 115.

The background system 12 comprises a commodity management module 121 which is provided for one or more sellers 3 to share one or more of their own commodities with the other sellers 3 for consignment sale, and to add one or more of the commodities which are shared by the other sellers 3 to their own online stores for selling as agent for the buyers 2 to shop and purchase, wherein each of the commodities is able to be distinguished by the order module 113 for whether it is a commodity owned by the seller 3 or a commodity shared from the other sellers 3 for consignment sale, wherein when the commodity is owned by the seller 3, the commodity management module 121 notifies the seller 3 for account processing commodity delivery processing, wherein when the commodity is a commodity for selling as agent, the commodity management module 121 notifies the original seller 3 of the commodity for selling as agent for account processing and commodity delivery processing.

Substantially, after the sellers 3 logged in, the sellers 3 are able to determine whether one or more of their commodities are able to be selling by the other sellers 3 as agent. If the sellers 3 are willing to provide one or more of their own commodities to be selling by the other sellers 3 as agent, the information of the particular commodities will be transmitted to the commodity management module 121 of the background system, so that the other sellers 3 are able to sell such commodities as agent and the commodity information thereof will be shown in the commodity database 115 too. In addition, the order module 113 will transmit the shopping and purchasing information of the buyer 2 to the background system 12 for providing buyer information, payment information, delivery information of the buyer 2 to the respective seller 3, so that the seller 3 may check the delivery status of the commodity through the order module 13. Also, the order module 113 can automatically determine orders into categories: the seller's own commodity or the commodity for consignment sale. If the commodity is the seller's 3 own commodity, the seller 3 will be notified to check its payment account and deliver the commodity. If the commodity is the commodity for consignment sale to the seller 3, the background system 12 will notify the seller 3 for selling as agent and the original seller 3 who owns the commodity, provide the order information to the original seller 3 who owns the commodity, and notify the original seller 3 who owns the commodity to check the payment account and deliver the commodity, wherein the original seller 3 who owns the commodity will pay the payable commission to the seller 3 who is selling as agent through the background system 12 in order to complete an order transaction.

Accordingly, the business transaction network system of the present invention enables each seller 3 can determine whether one or more of its commodities are able to be selling by the other sellers 3 as agent, or to determine whether it is willing to sell commodities of the other sellers in the business transaction network system as agent, so that the sellers 3 do not need to worry about out of stock and hoarding of commodities, resulting in better and easier circulation and sale of commodities, as well as more clear and detail account information for ease of the sellers to manage their commodities and accounts for better overall utility of the business transaction network system of the present invention.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A business transaction network system, comprising:
a foreground system and a background system;
said foreground system comprising:
a login module enabling one or more buyers and one or more sellers inputting personal information thereof and linking to a commodity database for enabling said buyers to browse commodities in said commodity database;
a shopping cart module enabling said buyers shopping and purchasing said commodities in said commodity database; and
an order module, having an order database, transmitting shopping information to said background system when any of said buyers purchases any of said commodities in said commodity database;
said background comprising a commodity management module for said sellers to share commodities thereof to said other sellers for selling as agent and to share said commodities of said other sellers in online stores of said sellers for selling as agent for said buyers to shop and purchase, wherein each of said commodities is able to be distinguished by said order module for whether said commodity is owned by said seller or a commodity shared from said other sellers for selling as agent, wherein when said commodity is owned by said seller, said commodity management module notifies said seller for account processing and commodity delivery processing, wherein when said commodity is a commodity for consignment sale, said commodity management module notifies said seller who originally owns said commodity for account processing and commodity delivery processing.

2. The business transaction network system, as recited in claim 1, wherein said login module comprises a member database, wherein after said seller logged in, said seller is able to determine whether one or more of said commodities thereof are to be selling by said other sellers as agent, wherein when said seller is willing to provide one or more of said commodities thereof for selling by said other sellers as agent, information of said one or more commodities are transmitted to said commodity management module of said back system, so that said other sellers are able to sell said commodities as agent while said commodity information is shown in said commodity database.

3. The business transaction network system, as recited in claim 1, wherein said order module transmits shopping and purchasing information of said buyer to said background system for providing buyer information, payment information, delivery information of said buyer to said respective seller, so that said seller is able to check a delivery status of said commodity through said order module.

4. The business transaction network system, as recited in claim 2, wherein said order module transmits shopping and purchasing information of said buyer to said background system for providing buyer information, payment information, delivery information of said buyer to said respective seller, so that said seller is able to check a delivery status of said commodity through said order module.

5. The business transaction network system, as recited in claim 1, wherein said order module is able to automatically categorize orders of commodity into commodity owned by said seller and commodity for consignment sale by said other sellers and transmit to said background system for processing respectively.

6. The business transaction network system, as recited in claim 2, wherein said order module is able to automatically categorize orders of commodity into commodity owned by said seller and commodity for consignment sale by said other sellers and transmit to said background system for processing respectively.

7. The business transaction network system, as recited in claim 3, wherein said order module is able to automatically categorize orders of commodity into commodity owned by said seller and commodity for consignment sale by said other sellers and transmit to said background system for processing respectively.

8. The business transaction network system, as recited in claim 4, wherein said order module is able to automatically categorize orders of commodity into commodity owned by said seller and commodity for consignment sale by said other sellers and transmit to said background system for processing respectively.

9. The business transaction network system, as recited in claim 1, wherein said order module determines whether said commodity is a commodity for consignment sale, wherein when said commodity is determined as said commodity for consignment sale, said seller who owns said commodity pays a payable commission to said seller who is selling as agent through said background system.

10. The business transaction network system, as recited in claim 2, wherein said order module determines whether said commodity is a commodity for consignment sale, wherein when said commodity is determined as said commodity for consignment sale, said seller who owns said commodity pays a payable commission to said seller who is selling as agent through said background system.

11. The business transaction network system, as recited in claim 3, wherein said order module determines whether said commodity is a commodity for consignment sale, wherein when said commodity is determined as said commodity for consignment sale, said seller who owns said commodity pays a payable commission to said seller who is selling as agent through said background system.

12. The business transaction network system, as recited in claim 4, wherein said order module determines whether said commodity is a commodity for consignment sale, wherein when said commodity is determined as said commodity for consignment sale, said seller who owns said commodity pays a payable commission to said seller who is selling as agent through said background system.

13. The business transaction network system, as recited in claim 5, wherein said order module determines whether said commodity is a commodity for consignment sale, wherein when said commodity is determined as said commodity for consignment sale, said seller who owns said commodity pays a payable commission to said seller who is selling as agent through said background system.

14. The business transaction network system, as recited in claim 6, wherein said order module determines whether said commodity is a commodity for consignment sale, wherein when said commodity is determined as said commodity for consignment sale, said seller who owns said commodity pays a payable commission to said seller who is selling as agent through said background system.

15. The business transaction network system, as recited in claim 6, wherein said order module determines whether said commodity is a commodity for consignment sale, wherein when said commodity is determined as said commodity for consignment sale, said seller who owns said commodity pays a payable commission to said seller who is selling as agent through said background system.

16. The business transaction network system, as recited in claim 7, wherein said order module determines whether said commodity is a commodity for consignment sale, wherein when said commodity is determined as said commodity for consignment sale, said seller who owns said commodity pays a payable commission to said seller who is selling as agent through said background system.

17. The business transaction network system, as recited in claim 8, wherein said order module determines whether said commodity is a commodity for consignment sale, wherein when said commodity is determined as said commodity for consignment sale, said seller who owns said commodity pays a payable commission to said seller who is selling as agent through said background system.
